(19) United States
(12) Patent Application Publication
(10) Pub. No.: US 2006/0192505 A1
(43) Pub. Date: Aug. 31, 2006

(54) Bellows-supporting structure and movable stage device

(75) Inventor: Tsutomu Hiroki, Yamanashi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTON LIMITED, Tokyo (JP)

(21) Appl. No.: 10/565,978

(22) PCT Filed: Jul. 21, 2004
(86) PCT No.: PCT/JP04/10685

§ 371 Date: Jan. 26, 2006

(30) Foreign Application Priority Data
Jul. 28, 2003 (JP) 2003-280549

(51) Int. Cl. B25J 9/16

(52) U.S. Cl. 318/1

(57) ABSTRACT

A structure for supporting a bellows (1) from the inside has a guiding track (8) provided inside the bellows and extending in the axial direction of the bellows. A moving member (10) is provided so as to be movable in the bellows' axial direction on the guiding track. The moving member and the bellows are connected by an intermediate supporting member (5).

### FIELD OF THE INVENTION

The present invention relates to a bellows supporting structure and a movable stage device capable of enabling a long range of motion of a bellows without stress concentration which is often problematic; and, more particularly, to such type of technology that is applicable in the field of semiconductor processing system. Here, semiconductor processing includes various processes performed to manufacture semiconductor devices or structures coupled with semiconductor devices, e.g., wiring and electrodes, on a substrate to be processed such as a wafer, LCD (liquid crystal display) glass substrate or FPD (flat panel display) glass substrate by forming a semiconductor layer, insulating layer, conductive layer and the like on the substrate to be processed into specified patterns.

### BACKGROUND OF THE INVENTION

In manufacturing a semiconductor device, it is common for a substrate to be processed (object to be processed), e.g., a semiconductor wafer, to be moved or transferred in a vacuum chamber. Here, a bellows is used as a device for coupling a movable part, which is capable of a rectilinear movement in the vacuum chamber, to a fixed part and for environmentally sealing the vacuum side from the ambient (see, e.g., Japanese Patent Laid-open Application No. H11-16979). A non-uniform extension and contraction of convolutions of the bellows can unduly compromise the useful life of such bellows. To solve such problems, there has been proposed an equal distance guiding mechanism of the bellows, for supporting a long bellows with a plurality of supporting bodies and uniformly extending and contracting the bellows (see, e.g., Japanese Patent Laid-open Application No. 2000-136907).

FIG. 9A is a vertical sectional view schematically showing a conventional bellows supporting structure (inner supporting structure). As illustrated in FIG. 9A, connection flanges 2 and 3 are provided at both end portions of a bellows 1. One or more intermediate rings 5 that are formed separately from the bellows 1 are provided at an intermediate portion of the bellows 1. A shaft 30 for supporting and guiding the intermediate ring 5 is provided at an axial part in the bellows 1.

FIG. 9B depicts a vertical sectional view schematically illustrating a conventional bellows supporting structure (outer supporting structure). As illustrated in FIG. 9B, the connection flanges 2 and 3 are provided at both end portions of the bellows 1. One or more intermediate rings 5 that are formed separately from the bellows 1 are provided at the intermediate portion of the bellows 1. Shafts 31 for supporting and guiding the intermediate rings 5 are provided on the outside of the bellows 1.

With the structures illustrated in FIGS. 9A and 9B, it is possible to avoid stress concentration (buckling or deformation) caused by bending or the like which is common in the bellows when the movement range is long. However, such mechanism is undesirable in two ways: it can generate contaminating particles; it is difficult to provide sufficient space in the bellows for the mechanism.

### SUMMARY OF THE INVENTION

It is, therefore, an object of the present invention to provide a bellows supporting structure and movable stage device that can avoid generating contaminating particles and allow sufficient space in a bellows.

It is another object of the present invention to provide a bellows supporting structure and a movable stage device, capable of extending the useful life of a bellows and providing enough room to accommodate a driving member of a movable part and the like inside the bellows.

It is still another object of the present invention to provide a bellows supporting structure and a movable stage device, capable of simplifying its structure and reducing the costs.

In accordance with one aspect of the invention, there is provided an inner supporting structure of a bellows, the structure including: guiding tracks installed in the bellows, extending along an axial direction of the bellows; moving members slidably installed on the guiding tracks along the axial direction; and intermediate supporting members for coupling the moving members and the bellows.

In accordance with another aspect of the invention, there is provided a movable stage device for moving an object to be processed in a vacuum chamber or a chamber filled with specified gas or liquid, the device including: a linear guide provided between a first and a second sidewall in the chamber; a movable frame that is movable along a longitudinal direction of the linear guide inserted into the movable frame to pass therethrough; a pair of bellows surrounding the linear guide between the movable frame and the first and the second sidewall, the movable frame and the pair of bellows forming an auxiliary space airtightly isolated from the other portions of the chamber; a driving member for moving the movable frame along the linear guide; guiding tracks installed in the pair of bellows, extending along an axial direction of the pair of bellows; moving members movably positioned on the guiding tracks along the axial direction; and intermediate supporting members for connecting the moving members and the pair of bellows.

### BRIEF DESCRIPTION OF THE DRAWINGS

FIG. 1 is a vertical sectional view schematically showing a bellows supporting structure in accordance with a preferred embodiment of the present invention;

FIG. 2 describes a left side view of the structure in FIG. 1;

FIG. 3 provides a right side view of the structure in FIG. 1;

FIG. 4 presents a perspective view of the structure in FIG. 1;

FIG. 5A represents a top perspective view of moving members of the structure in FIG. 1;

FIG. 5B offers a bottom perspective view of the moving members in FIG. 5A;

FIG. 6A sets forth a plan view showing a state when the moving members of the structure in FIG. 1 are in direct contact with each other;

FIG. 6B provides a plan view describing a state when the moving members illustrated in FIG. 6A are separated from each other;

FIG. 7 presents a perspective view schematically depicting a movable stage device in accordance with a preferred embodiment of the present invention;

FIG. 8 represents a partially cutaway perspective view showing a semiconductor processing system having therein the movable stage device illustrated in FIG. 7;

FIG. 9A offers a vertical sectional view schematically depicting a conventional bellows supporting structure (inner supporting structure); and

FIG. 9B shows a vertical sectional view schematically illustrating another conventional bellows supporting structure (outer supporting structure).

### DETAILED DESCRIPTION OF THE PREFERRED EMBODIMENT

The present inventor has investigated the problems of a conventional bellows supporting structure, namely, challenges when it is applied to a driving system of a semiconductor processing system to develop the present invention. As a result, the inventor has reached the following conclusion.

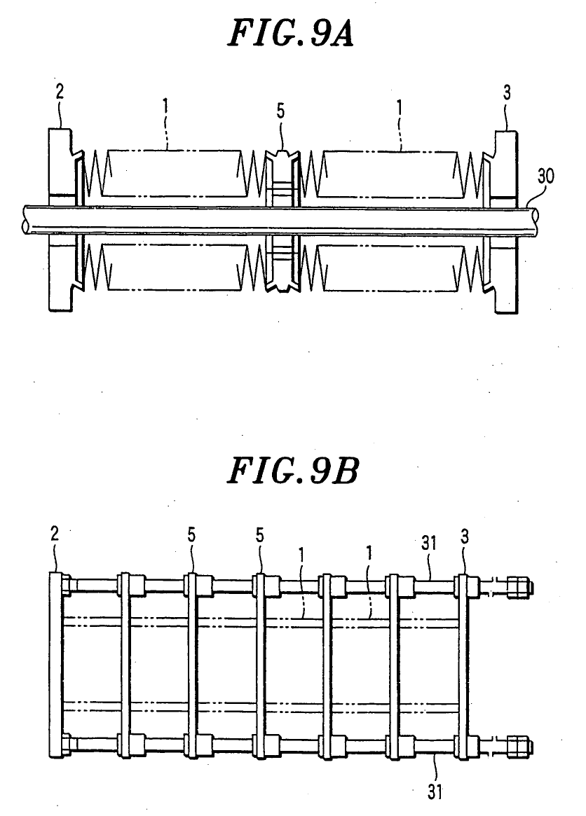

Excessive extension or contraction of a bellows will unduly compromise the useful life of the bellows. To solve such a problem, a stopper can be provided on the bellows. In both cases of an inner and an outer supporting structure illustrated in FIGS. 9A and 9B, the stopper is generally provided on the outside of the bellows. If the stopper is provided on the outside of the bellows, a sliding part is also disposed on the outside of the bellows, in the same way as each member of the outer supporting structure. Accordingly, particles generated as different parts of the sliding part such as the stopper move against each other contaminate a vacuum chamber, including an in-process wafer.

To avoid such problems, it is considered that the stopper is provided inside the bellows, in the same manner as each member of the inner supporting structure. However, this makes a large space inside the bellows to be occupied by the stopper. Consequently, there is not enough space in the bellows to accommodate a driving member of a movable part therein.

Hereinafter, a preferred embodiment of the present invention conceived based on the above investigation will be described with reference to the accompanying drawings. Further, in the following explanation, like reference numerals will be assigned to like parts having substantially the same functions, and their similar descriptions will be provided only when necessary.

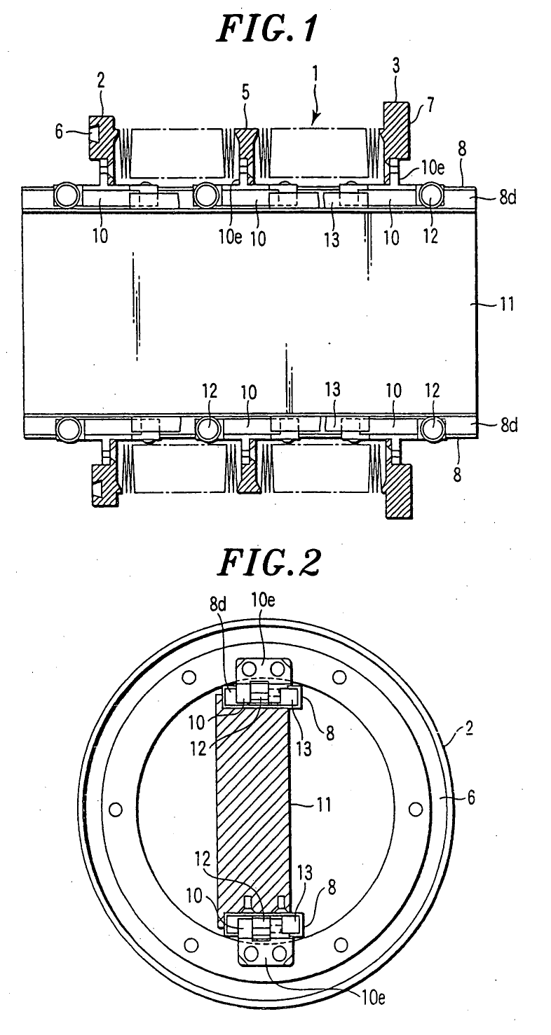

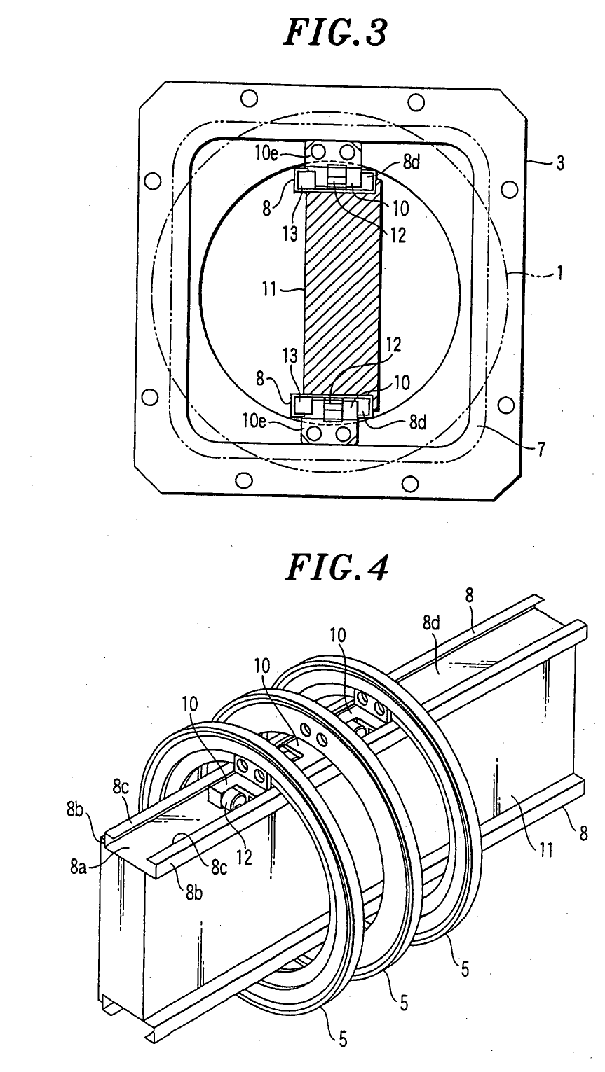

FIG. 1 is a vertical sectional view schematically showing a bellows supporting structure in accordance with a preferred embodiment of the present invention. FIGS. 2, 3 and 4 describe a left side view, a right side view and a perspective view of the structure shown in FIG. 1, respectively.

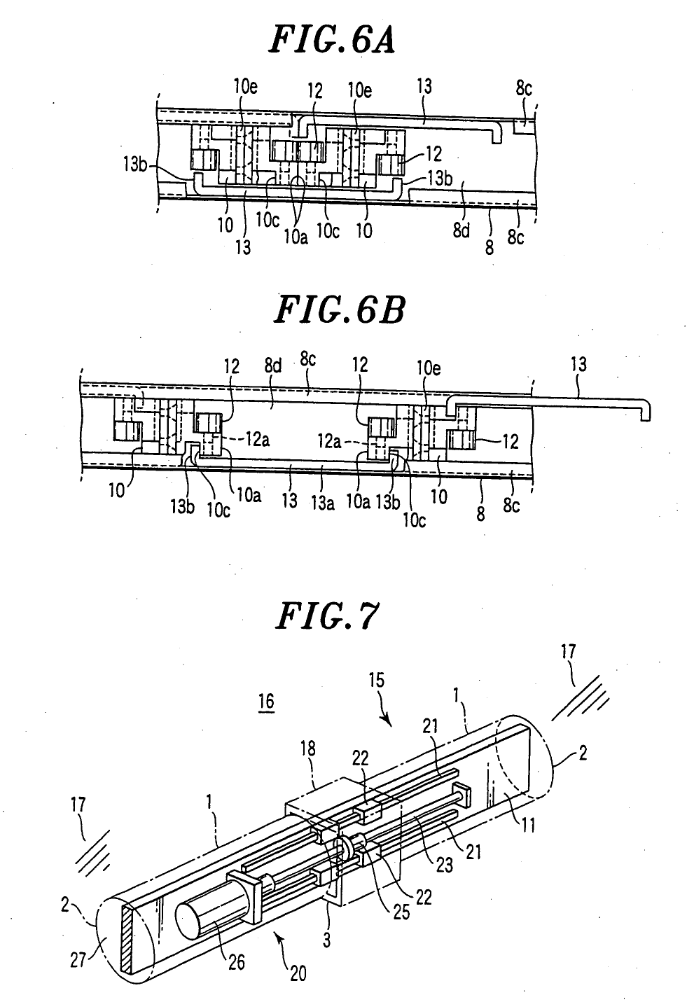

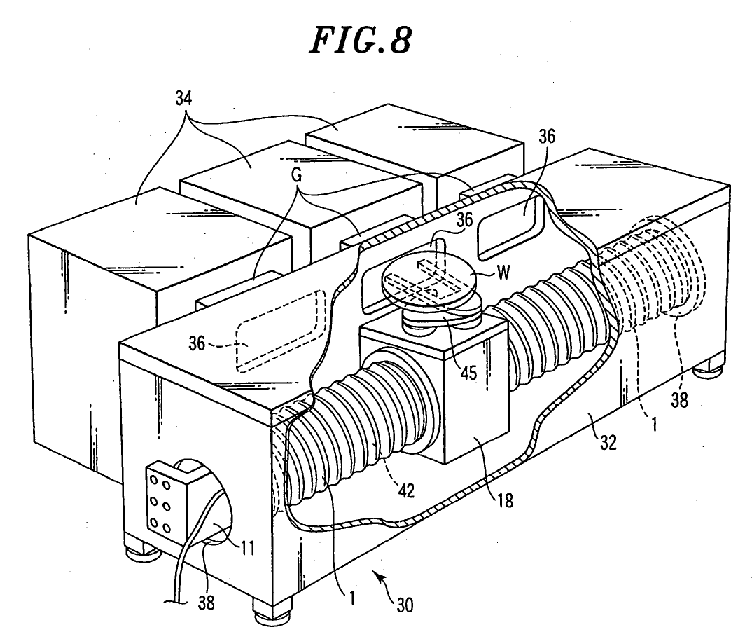

As illustrated in FIGS. 1 to 4, a bellows 1 is formed by a cylindrical body that is extensible and contractable in a longitudinal direction thereof. Provided at one end portion of the bellows 1 is a flange 2 for fixing it on a fixed part, e.g., a sidewall of a vacuum chamber. Provided at the other end portion of the bellows 1 is a flange 3 for connecting it to a movable part, e.g., a movable frame (to be described later with reference to FIG. 7). At an intermediate portion of the bellows 1, one or more (a single or a plurality of) intermediate rings 5 serving as intermediate supporting members are provided separately therefrom or in combination therewith. In this example, the separately provided intermediate ring 5 is illustrated.

The fixing side flange 2 has an annular attachment groove 6 on one side. Disposed in the attachment groove 6 is an O-ring (a filling piece: not shown) for airtightly sealing a space between the flange 2 and the sidewall of the vacuum chamber. A periphery of the movable side flange 3 has a square front profile, which is equal to one end side of a movable frame. Formed on one end side of the flange 3 is a flat contact surface 7 for being in direct contact with the O-ring installed on one end side of the movable frame.

The bellows 1 is formed by welding together inner and outer peripheries of a plurality of ring-shaped thin films made of, e.g., a metal such as stainless steel or the like alternately. The intermediate ring 5 is composed of a ring having an approximately same diameter as that of the bellows 1. The flanges 2 and 3 and the intermediate ring 5 are respectively connected to end portions of the bellows 1 by the welding. One or more intermediate rings 5 are provided at the intermediate portion of the bellows 1 depending on a length of the bellows 1 at appropriate intervals.

Horizontally provided in the bellows 1 are two rails 8 serving as guiding members (guiding tracks) along a longitudinal direction (axial direction) thereof. The two rails 8 are respectively provided at an inner upper and an inner lower portion of the bellows 1 so that they can be close to an inner surface of the bellows 1. The rails 8 are preferably flat and thin so that they only occupy limited space.

Moving blocks 10, i.e., main bodies of moving members, are movably supported on the rails 8 along a longitudinal direction thereof. The intermediate rings 5 are respectively installed at the moving blocks 10. Thus, the moving blocks 10 are connected to the inner surface of the bellows 1 via the intermediate rings 5.

Specifically, each of the rails 8 has a bottom surface portion 8a; both side surface portions 8b that are upright from both sides of the bottom surface portion 8a; and flange portions 8c obtained by inwardly bending upper peripheries of both side surface portions 8b so that they face each other. Thus, the rail 8 has a guiding groove portion 8d surrounded by the above portions, and a cross section of the guiding groove portion 8d is approximately C-shaped. The guiding groove portion 8d of the upper rail 8 faces upward, and the guiding groove portion 8d of the lower rail 8 faces downward.

For example, the two rails 8 are respectively provided at an upper and a lower portion of a crossbeam 11 inserted into an inner portion of the bellows 1 to pass therethrough. The crossbeam 11 in this example is eccentrically disposed with respect to an axis of the bellows 1 in order to install a driving member (to be described later with reference to FIG. 7) of the movable frame (movable part).

It is also possible to provide a single rail 8, instead of the two rails 8, at an inner upper portion of the bellows 1 so that the guiding groove portion 8d faces upward. However, if the two rails 8 are provided at the inner upper and the inner lower portion of the bellows 1, the intermediate ring 5 can be guided while being more securely supported.

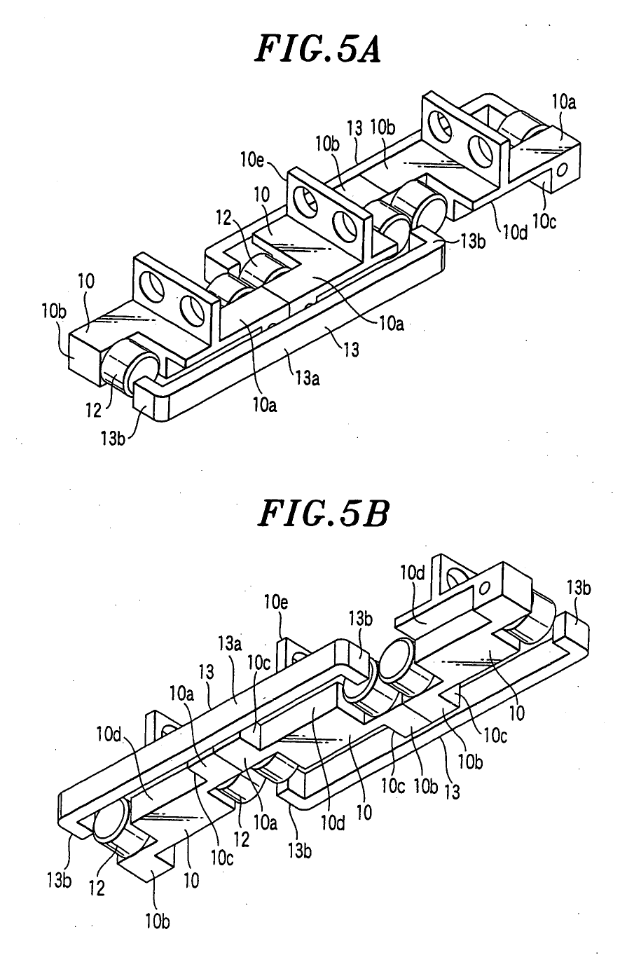

FIG. 5A represents a top perspective view of a moving member of the structure illustrated in FIG. 1; FIG. 5B offers a bottom perspective view of the moving member of the structure depicted in FIG. 5A; FIG. 6A sets forth a plan view showing a state where the moving members of the structure illustrated in FIG. 1 are in direct contact with each other; and FIG. 6B provides a plan view describing a state where the moving members illustrated in FIG. 6A are separated from each other.

The moving blocks 10, i.e., the main bodies of the moving members, are movably provided in the guiding groove portion 8d of each rail 8 in series as many as the number of the intermediate rings 5. The moving blocks 10 are slidably or movably provided without being separated from the guiding groove portion 8d. Further, two rollers (wheels) 12 are rotatably supported via support axes 12a on each of the moving blocks 10 so that they can roll on the rails 8. Further, if the moving blocks 10 are able to smoothly slide in the guiding groove portion 8d, the rollers 12 become unnecessary.

Protruding parts 10a and 10b protruded in a traveling direction are provided at a front and a rear side of the moving block 10 so that they can be symmetric with respect to a point. The two rollers 12, each having one end fixed on an approximately central portion of a side surface of each of the protruding parts 10a and 10b, are supported via the support axes 12a at the front and the rear side of the traveling direction of the moving block 10. In other words, the front roller 12 and the front protruding part 10a face each other across a central line of the moving block 10 extending in an axial direction of the bellows 1 (i.e., at a right and a left side thereof), and so do the rear roller 12 and the rear protruding part 10b.

The protruding parts 10a and 10b are in direct contact with each other before the rollers 12 of the front and the rear moving block 10 are in contact with each other, thereby preventing an excessive contraction of the bellows 1. In other words, a minimum distance of the moving blocks 10 adjacent to each other is set by the protruding parts 10a and 10b. In this example, as illustrated in FIGS. 5A to 6B, the moving blocks 10 adjacent to each other are disposed so that the protruding parts 10a or the protruding parts 10b are positioned on the same side (right or left side). Therefore, the minimum distance of the moving blocks 10 adjacent to each other is set by a minimum contact distance between the protruding parts 10a or 10b.

Further, as shown in FIG. 6B, approximately “ [symbol] ” character-shaped hook bars 13, for preventing an excessive extension of the bellows 1, are provided in the guiding groove portions 8d of the rails 8. The hook bars 13 connect the moving blocks 10 adjacent to each other in a longitudinal direction of the bellows 1 such that a distance between them is within a set range. In other words, a maximum distance between the moving blocks 10 adjacent to each other is determined by the hook bars 13. In this example, the hook bars 13 are disposed on the right and left side alternately with respect to the central line of the moving block 10 extending in the axial direction of the bellows 1. That is, as illustrated in FIG. 5B, in consecutive three moving blocks 10, i.e., a first, second and third moving block, if the first and the second moving blocks 10 are tied up to the right hook bar 13, the second and the third moving blocks 10 are tied up to the left hook bar 13.

To be specific, the hook bars 13 are formed by bending both end portions of long rods 13a at approximately right angles in the same direction, wherein such end portions thereof become hook portions 13b. Snags 10c for engaging the hook portions 13b of the hook bars 13 are provided at lower portions of the protruding parts 10a or the protruding parts 10b facing each other in the adjacent moving blocks 10 (see, FIG. 5B). Provided at both side portions of the moving blocks 10 are groove portions 10d for allowing the hook portions 13b to move.

The hook bars 13 are slidably supported at both side portions in the guiding groove portion 8d along a longitudinal direction while being covered by the flange portions 8c so that they are not separated therefrom. It is preferable that the length of each hook bar 13 is approximately equal to the total length of two moving blocks 10 when they are in direct contact with each other. Accordingly, this avoids an interference between adjacent hook bars 13 when moving blocks 10 are in direct contact with each other. Hence, it is possible to ensure an adequate level of contraction of the bellows 1, which in turn allows sufficient room for extension of the bellows 1 when the adjacent moving blocks 10 are separated (parted) from each other.

A fixing piece 10e for fixing each of the intermediate rings 5 is protrudingly provided at an approximately central portion of each moving block 10. The intermediate ring 5 is installed at the fixing piece 10e by screws or welding.

As described above, in such bellows supporting structure, one or more intermediate rings 5 are disposed at the intermediate portion of the bellows 1 in combination therewith or separately therefrom. The rails 8 are provided near an inner surface of the bellows 1 along a longitudinal direction thereof. The moving blocks 10 are movably supported on the rails 8 along the longitudinal direction thereof. The intermediate rings 5 are supported at the moving blocks 10. Accordingly, contaminating particles are not generated to impair the integrity of the controlled conditions. Further, it is possible to ensure a sufficient space in the bellows 1, so that a driving member of the movable part and the like can be disposed in the bellows 1.

The rails 8 have guiding groove portions 8d having an approximately C-shaped cross section. The rails 8 are provided at an upper and a lower portion along a horizontal direction so that the guiding groove portions 8d face upward and downward. Therefore, it is possible to horizontally and securely support the bellows 1 via the intermediate rings 5.

The contact between the moving blocks 10 adjacent to each other in a longitudinal direction of the bellows 1 prevents the bellows 1 from being excessively contracted. Thus, the excessive contraction of the bellows 1 can be prevented with a simple structure, thereby simplifying the structure, extending its useful life and reducing the costs.

Alternately disposed on the right and left side of the rails 8 are the approximately “ [symbol] ” character-shaped hook bars 13 for tying up the moving blocks 10 adjacent to each other in a longitudinal direction of the bellows 1 at specific intervals in order to prevent an excessive extension of the bellows 1. Accordingly, the excessive extension of the bellows 1 can be prevented with a simple structure, thereby simplifying of the structure, extending its useful life and reducing the costs.

FIG. 7 presents a perspective view schematically depicting a movable stage device in accordance with a preferred embodiment of the present invention.

As illustrated in FIG. 7, a movable stage device 15 is provided to transfer an object to be processed, e.g., a semiconductor wafer, in a controlled condition, e.g., the vacuum chamber 16. The movable state device 15 includes the crossbeam 11 hung horizontally between the both sidewalls 17 in the vacuum chamber 16. The movable frame 18 is movably disposed along the longitudinal direction of the crossbeam while surrounding a periphery of the crossbeam 11. The driving member 20 is provided in order to reciprocate the movable frame 18 along the crossbeam 11. A pair of bellows 1 is provided to cover the crossbeam 11 positioned at both sides of the movable frame 18. Each of the bellows 1 has one end portion fixed on the sidewall 17 via the flange 2, and the other end portion connected to the profile of the movable frame 18 via the flange 3.

The supporting structure of the bellows 1 is the same as that described with reference to FIGS. 1 to 6B. In other words, as illustrated in FIGS. 1 to 4, the bellows 1 is formed by a cylindrical body that is extensible and contractable in a longitudinal direction thereof. Provided at one end portion of the bellows 1 is the flange 2 for fixing it on a fixed part, e.g., the sidewall of a vacuum chamber. Provided at the other end portion of the bellows 1 is the flange 3 for connecting it to the movable part 18. One or more (a single or a plurality of) intermediate rings 5 serving as intermediate supporting members are provided at an intermediate portion of the bellows 1 in combination therewith or separately therefrom.

Horizontally provided in the bellows 1 are two rails 8 serving as guiding members (guiding tracks) along a longitudinal direction (axial direction) thereof. The two rails 8 are respectively provided at an inner upper and an inner lower portion of the bellows 1 so that they can be close to an inner surface of the bellows 1. The moving blocks 10, i.e., the main bodies of the moving members, are movably supported on the rails 8 along a longitudinal direction thereof. The intermediate rings 5 are respectively installed at the moving blocks 10. Thus, the moving blocks 10 are connected to the inner surface of the bellows 1 via the intermediate rings 5.

As shown in FIG. 7, a linear guide 21 is provided on one side surface of the crossbeam 11 along a longitudinal direction thereof. The movable frame 18 is slidably supported by the linear guide 21 via a slider 22. As a driving member 20, a ball screw 23 is rotatably installed at one side surface of the crossbeam 11 along a longitudinal direction thereof. The movable frame 18 is fixed to a female screw member 25 screwed to the ball screw 23. Connected to one end portion of the ball screw 23 is a rotation driving motor 26. Accordingly, the movable frame 18 can move in a horizontal direction via the female screw member 25 by the rotation of the ball screw 23.

An inner space of the bellows 1 communicates with the atmosphere via through holes 27 formed on the sidewalls 17. In other words, the driving member 20 or the supporting structure (supporting mechanism) of the bellows 1 is provided inside the bellows 1, i.e., on the atmospheric side. Thus, it is possible to prevent contaminating particles generated from the driving member 20 or the sliding part of the supporting structure from scattering and floating into the vacuum chamber 16 and, further, to prevent a wafer from being contaminated. Moreover, the movable frame 18 can be provided with a revolvable, bendable and stretchable transfer arm unit (see, FIG. 8) for transferring a wafer in a horizontal direction while handling a single wafer via an elevating mechanism.

FIG. 8 represents a partially cutaway perspective view showing a semiconductor processing system having therein the movable stage device illustrated in FIG. 7.

As depicted in FIG. 8, such semiconductor processing system 30 is formed by a housing extended in a horizontal direction and, further, has a common transfer chamber 32 (represented as the vacuum chamber 16 in FIG. 7) whose inner portion can be maintained in a vacuum atmosphere. Connected to one side surface of the common transfer chamber 32 are three vacuum processing chambers 34 for performing a processing treatment on a semiconductor wafer in a vacuum. Connected to the other side surface of the common transfer chamber 32 are two load-lock chambers (not shown) serving as pressure buffer chambers used when a wafer is transferred.

Formed on side surfaces of the transfer chamber 32 are ports 36 for loading/unloading a semiconductor wafer W serving as a substrate to be processed into/from the vacuum processing chamber 34 and load-lock chambers. The ports 36 is respectively provided with gate valves G for airtightly isolating the vacuum processing chambers 34 and the load-lock chambers from the transfer chamber 32.

Provided in the common transfer chamber 32 is the movable stage device 15 illustrated in FIG. 7. The movable stage device 15 has the movable frame 18 and a pair of bellows 1 disposed on both sides of the movable frame 18. The movable frame 18 and the pair of bellows 1 form therein an auxiliary space 42 airtightly isolated from an inner atmosphere of the common transfer chamber 32. The auxiliary space 42 communicates with an atmospheric atmosphere through openings 38 formed at both end walls of the common transfer chamber 32.

The driving structure and the supporting structure illustrated in FIG. 7 are disposed in the auxiliary space 42 in the movable frame 18 and the bellows 1. With such inner structures, the movable frame 18 can horizontally move between both end walls of the common transfer chamber 32. Furthermore, the revolvable, bendable and stretchable transfer arm unit 45 is provided on the movable frame 18 via the elevating mechanism in order to handle a wafer W. By using the transfer arm unit 45, the wafer W is loaded into and unloaded from the vacuum processing chamber 34 and the load-lock chambers via the ports 36.

In accordance with the movable stage device 15 illustrated in FIGS. 7 and 8, the auxiliary space 42 airtightly isolated from the inner atmosphere of the vacuum chambers 16 and 32 is formed in the bellows 1 disposed at both sides of the movable frame 18. Provided in the auxiliary space 42 are the movable frame 18 and the driving structure and the supporting structure of the bellows 1. By such configuration, a movement or a transfer of the wafer is carried out via the movable frame 18 (via the transfer arm unit 45 in FIG. 8). Therefore, it is possible to prevent particles from contaminating the vacuum chambers 16 and 32 or the wafer.

While the preferred embodiment of the present invention has been shown and described with reference to accompanying drawings, the present invention is not limited thereto and various changes and modification may be made without departing from the spirit and scope of the invention. For example, in the embodiment, there has been described an example of a horizontal bellows. However, the present invention can be applied to a bellows•supporting structure of a vertical bellows. Further, although the intermediate rings are formed separately from the bellows in the embodiment, the intermediate rings can be formed in combination therewith. Besides, the intermediate rings (intermediate supporting members) and the moving members can be formed in combination.

In the embodiment, the rails are illustrated as guiding members (guiding tracks). However, a roller conveyer (roller bearing) in which rollers are arranged in a longitudinal direction can be used as the guiding track. In such case, the moving members move on the roller conveyer. The rails (guide members) can be positioned on the right and left side without being limited to an upper and a lower portion.

A chamber for accommodating therein the movable stage device can be filled with, e.g., a specific gas (air, gas or the like) or liquid (water, liquid chemical or the like) without being limited to a vacuum. An inner pressure thereof can be an atmospheric pressure, positive pressure or negative pressure. In case it is used in an atmosphere of a corrosive gas, the bellows can be made of a material having a corrosiveness resistance such as Teflone (a registered trademark) without being limited to a metal material.

### INDUSTRIAL APPLICABILITY

In accordance with the bellows supporting structure and the movable stage device of the present invention, it is possible to prevent contaminating particles from being generated and, further, to allow a sufficient space in the bellows.

What is claimed is:

1. An inner supporting structure of a bellows, the structure comprising:
guiding tracks installed in the bellows, extending along an axial direction of the bellows;
moving members slidably installed on the guiding tracks along the axial direction; and
intermediate supporting members for coupling the moving members and the bellows.

2. The inner supporting structure of claim 1, wherein the guiding tracks include an upper and a lower track respectively positioned at an inner upper and an inner lower portion of the bellows so as to be adjacent to an inner surface of the bellows.

3. The inner supporting structure of claim 1, wherein the moving members include moving blocks movably installed on the guiding tracks without being allowed to derail therefrom, respectively.

4. The inner supporting structure of claim 3, wherein each of the guiding tracks has a guiding groove portion having an approximately C-shaped cross section, and the moving blocks are slidably installed in the guiding groove portion.

5. The inner supporting structure of claim 3, wherein the moving members include rollers axially supported on the moving blocks so as to slide on the guiding tracks.

6. The inner supporting structure of claim 5, wherein there are provided the plural moving members that are slidable with respect to each other along the axial direction and have protruding parts capable of contacting with each other before the rollers touch each other so as to set a minimum distance between the plural moving members.

7. The inner supporting structure of claim 6, wherein the rollers are axially supported on sidewalls of the protruding parts.

8. The inner supporting structure of claim 6, wherein the rollers include a first and a second roller respectively provided at a front and a rear portion of each of the moving blocks, and the first and the second roller are alternately positioned with respect to a central line of the moving blocks extending in the axial direction; and wherein the protruding parts include a first and a second protruding part provided at a front and a rear portion of each of the moving blocks, and the first and the second protruding part are alternately arranged with respect to the central line, the first and the second protruding part of two adjacent moving members being positioned on an opposite side with respect to the central line.

9. The inner supporting structure of claim 3, wherein there are provided the plural moving members that are slidable with respect to each other along the axial direction, the structure further comprising coupling members coupled with the moving blocks so as to determine a maximum distance between the plural moving members.

10. The inner supporting structure of claim 9, wherein each of the guiding tracks has a guiding groove portion having an approximately C-shaped cross section, and the moving blocks and the coupling members are slidably installed in the guiding groove portion.

11. The inner supporting structure of claim 9, wherein, as for a first, a second and a third moving members arranged side by side, the coupling members include a first hook for determining a maximum distance between the first and the second moving member and a second hook for determining a maximum distance between the second and the third moving member, wherein the first and the second hook are alternately arranged with respect to a central line of the moving blocks extending in the axial direction.

12. A movable stage device for moving an object to be processed in a vacuum chamber or a chamber filled with specified gas or liquid, the device comprising:
a linear guide provided between a first and a second sidewall in the chamber;
a movable frame that is movable along a longitudinal direction of the linear guide inserted into the movable frame to pass therethrough;
a pair of bellows surrounding the linear guide between the movable frame and the first and the second sidewall, the movable frame and the pair of bellows forming an auxiliary space airtightly isolated from the other portions of the chamber;
a driving member for moving the movable frame along the linear guide;
guiding tracks installed in the pair of bellows, extending along an axial direction of the pair of bellows;
moving members movably positioned on the guiding tracks along the axial direction; and
intermediate supporting members for connecting the moving members and the pair of bellows.

13. The movable stage device of claim 12, wherein the chamber is set to have a vacuum atmosphere therein, and the auxiliary space communicates with an atmospheric atmosphere.

14. The movable stage device of claim 12, wherein the driving member is positioned at a predetermined location in the pair of bellows.

15. The movable stage device of claim 13, further comprising a bendable and stretchable transfer arm unit provided on the movable frame, for handling the object to be processed.

16. The movable stage device of claim 15, further comprising a transfer chamber housing forming the chamber, wherein the transfer chamber housing is connected to a processing apparatus for performing a semiconductor processing on the object to be processed.
